(19) United States
(12) Patent Application Publication
(10) Pub. No.: US 2002/0198746 A1
(43) Pub. Date: Dec. 26, 2002

(54) System and method for the rental of advertising and promotional space in public facilities

(75) Inventor: Matthew John Bending, Stirling (GB)

Correspondence Address: KEVIN M. KERCHER, BLACKWELL SANDERS PEPER MARTIN LLP, 720 OLIVE STREET, SUITE 2400, ST. LOUIS, MO, 63101, US

(73) Assignee: SpaceandPeople Limited

(21) Appl. No.: 09/885,650

(22) Filed: Jun. 20, 2001

(51) Int. Cl. G06F 17/60

(52) U.S. Cl. 705/5; 705/14

(57) ABSTRACT

A system and method for the rental of advertising space in buildings are disclosed for allowing advertisers to conveniently view information on a number of buildings where space is available for advertising and promotional activities. The system contains a database containing a variety of information on each building so that advertisers may browse to determine the most suitable building for their promotion. The system may also contain a search facility whereby advertisers can request the system to select a shortlist of suitable buildings based upon the requirements of the advertiser. Once the building or buildings have been selected, the system also provides a centralized booking facility whereby advertisers may book the desired space.

### FIELD OF THE INVENTION

The present invention generally relates to a system for the rental or sale of advertising and promotional space in buildings or facilities frequented by large numbers of the general public and, more particularly, to a method and system for the rental or sale of advertising and promotional space in shopping malls.

### BACKGROUND OF THE INVENTION

The past decade has seen continued growth in the number of new shopping malls being opened around the world, especially in Europe and the United States. This continued growth is allied to the fact that in many countries shopping is currently the fastest growing leisure pursuit. Thus, advertisers and brand managers have to come to recognize that buildings and facilities frequented by large numbers of the general public and, in particular, shopping malls are excellent places in which to demonstrate and promote products.

This type of advertising benefits both the advertiser and the shopping mall in question. For the owner of the mall, such promotional advertising generates income from previously unused retail space while also adding to the vitality and overall attraction of the mall to the public. On the advertiser's part, this type of promotion allows mass marketing whilst also permitting the customer to feel, see and hear products as they are demonstrated directly, as opposed to two-dimensional advertising in publications or on billboards. Furthermore, the rental of advertising and promotional space is far cheaper than advertising using conventional media such as the aforementioned publications or billboards. A yet further benefit to the advertiser of advertising in an environment such as a shopping mall is that customers are already in a purchasing mindset as demonstrated by their presence at the mall in the first place.

Despite the aforementioned benefits to both mall owner and advertiser, there is currently no national profile or advertising campaign in existence using the shopping mall as an advertising medium. If a mall is used as an advertising medium, it is invariably as part of a one-off, localized promotion. Due to this one-off format, there is no benchmarking to validate mall data and costs, and in many instances of one-off promotions unnecessary middlemen inflate costs as a result. For the advertiser, finding and booking space in a mall is currently a laborious, time-consuming process. This is not aided by the fact that the quality of information provided by each mall varies widely and is generally poor and unsubstantiated. In addition, most mall owners do not appreciate the functionality or potential of their malls with respect to promotional advertising of this nature.

In the light of the above, it is therefore an aim of the present invention to provide a system which will bring together advertisers and facility owners. This system will allow facility owners to successfully exploit unused space while also allowing advertisers to introduce their products to willing buyers. The system will be an interactive system whereby comprehensive information on available promotional space in major public facilities (e.g. shopping malls) throughout the advertiser's target country or region will be provided in order that advertisers can determine the most suitable sites and rent or buy advertising space at those sites.

### BRIEF DESCRIPTION OF THE DRAWINGS

Reference is now made more particularly to the drawings which illustrate the best presently known mode of carrying out the invention and wherein similar reference characters indicate the same parts throughout the views.

FIG. 1 is a schematic block diagram illustrating the pre-booking steps undertaken via the system of the present invention; and

FIG. 2 is a schematic block diagram of the post-booking process undertaken via the system.

### DETAILED DESCRIPTION

It is anticipated that the system of the present invention will be presented to customers via an interactive Internet website and telephone support center. The system comprises a central server which includes a random access memory, read-only memory and a central processing unit (CPU). The CPU may be a single commercially available processor or else may be a number of such processors operating in parallel.

Although the following description will refer to advertising in shopping malls only, it is to be understood that the system of the invention may be used to store details of any building or facility used by large numbers of the public, such as movie theatres or airports for example.

As stated above, the system is intended for use by advertisers who subscribe or register to use the system, along with facility owners whose facilities are listed thereon. The advertisers may be individual companies, advertising or PR agencies, or the like. A facility owner may either be an individual or else. a corporation or the like which owns a particular facility or a number of facilities.

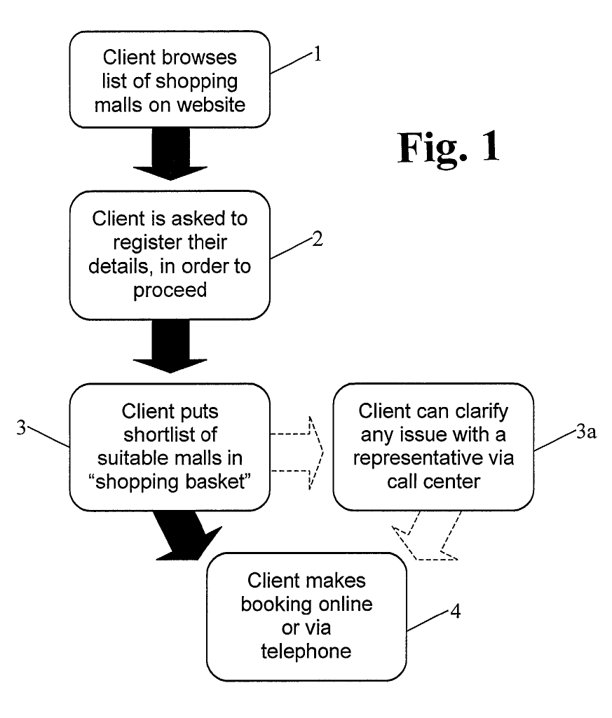

As shown at step 1 of FIG. 1, customers initially may use the site to browse for suitable malls or other facilities. The system has a database which contains information on a variety of different aspects to the mall, such as geographical location (where in the country or region the mall is located), exclusions (whether there are any products which the mall owner will not allow to be promoted in the facility), and pricing structure (how the cost of renting the available space is calculated) Further aspects may also be included relating to the mall customers, such as footfall statistics (the number of customers using the mall at given times) and customer demographics (statistics on mall customers such as age, employment, number in family, etc.). In addition aspects relating to the mall may be viewed, such as technical data relating to the mall, promotional site dimensions in the mall, who the key retail occupants of the mall are, and site availability.

Once the customer has identified the malls that may be of interest, they are invited to register various details on the system in order to proceed further, as shown at step 2. These details may include personal details about the person and their position within their company, their contact details, information concerning the company whose products are to be advertised, and such like. Each customer will then be given personal registration data—most preferably a username and password—which they should use when revisiting the site.

Once their information is registered (or, in the case where the user has previously used the site, their username and password have been corroborated by the system) the customer may proceed to step 3 and select the sites where they wish to proceed and rent advertising space in. Should the client have any queries at any time during the use of the system, they may call the telephone support center for assistance and clarification, as illustrated at step 3a. Once the client has selected the sites where they wish to advertise, then the system will proceed to step 4, where the client may either book advertising space on-line or via the telephone center if they prefer.

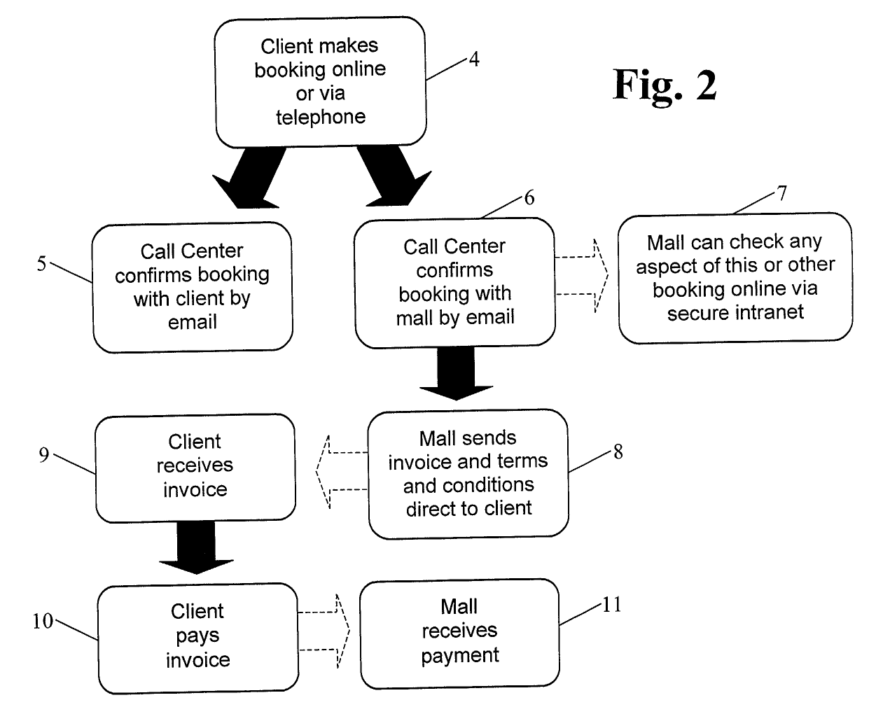

The website can also offer a fully interactive search facility whereby customers may input particular requirements for the advertising space that they require in a particular geographical area (e.g. footfall, size of retail space, pricing, etc.) and the search engine will list suitable malls in that area. This provides a quick alternative to the client browsing through the different pages for each mall, as at step 1 of FIG. 1. The procedure following the client's booking will now be described, with reference to FIG. 2. Once the client has made the booking at step 4, whether online or via the telephone center, a response e-mail is sent to the client at step 5 confirming the booking. At the same time, the call center confirms the booking with the mall at step 6, again by email. Each mall owner who subscribes to the system will be provided with access at any time to a secure intranet so that they may check any aspect of any booking, illustrated here at step 7. The intranet will enable the owner to log on to the system at anytime to check bookings at their facility or facilities, but as it is secure it will not be accessible by owners of other facilities, thereby preventing unauthorized access to by unscrupulous owners to their competitors' booking information.

Once the booking has been confirmed to both the client and the mall by the telephone center by way of steps 5 and 6, the client and mall then deal directly with each other. At the next step, step 8, the mall sends their invoice and terms and conditions of rental to the client directly for payment. Once the client receives the invoice at step 9, they pay the invoice directly to the mall at step 10. At step 11, the mall receives payment and the client can then proceed with advertising in the space provided in the mall at the agreed time.

With the addition of a telephone help center, it is possible for both the customer and mall owner to discuss any aspect of a booking with an assistant in the center, if anything is unclear. In addition, where a customer does not wish to use the Internet in order to book advertising space, they can arrange bookings directly with a telephone center assistant if desired. The telephone center may also be used to bring prospective customers to the attention of mall owners. The center is manned by a number of staff during business hours so that users or owners may obtain assistance.

The main advantage of the system in accordance with the present invention is that customer and mall owner are brought together via one site, putting buyers in touch with sellers, rather than a customer having to deal individually with each mall. However, the system provides further advantages for both customer and mall owner alike. For the mall owner, the system provides professional presentation of the mall that might otherwise be of poor quality, whilst also providing a national or international profile for the mall.

In addition, mall staff deal with a large number of different tasks during each working day, which may perhaps reduce their effectiveness when it comes to dealing with retail advertising and advertising customers. In contrast, the system of the present invention is dedicated solely to the providing of advertising space in facilities, and as such the customers and mall owners have a dedicated website and telephone center staff trained solely for the purpose of helping customers rent or buy advertising space. Furthermore, the system will significantly reduce the administration workload of mall staff, providing an excellent time saving opportunity.

The system also allows the mall owner to retain complete control of bookings, so that they may determine who advertises at their mall. Mall owners and customers may also negotiate prices directly with each other if desired.

For advertisers, the system provides a one-stop site that allows them to determine the availability of mall advertising space for their products. Information on all malls and facilities is instantly available so that advertisers can determine which sites are of interest in their campaign strategy. Furthermore, the information provided by the system is standardized so that clear comparisons can be made between sites.

It is to be understood that the above description is of only one preferred embodiment and that modifications and improvements can be incorporated without departing from the scope of the invention. For example, the system described may further have a capability whereby a reminder is sent to the mall owner via electronic mail prior to the arranged date of advertisement to check that the mall owner has received payment from the advertiser. Furthermore, an invoicing and terms and conditions tool may be provided so that the mall owner may undertake step 8 of the procedure with assistance from the system. A forecasting tool can also be provided to allow the mall owner to understand the income potential of providing advertising space to advertisers. Additionally, the system can be adapted to notify customers of advertising space which becomes available at the last minute, either by electronic mail or other means. Also, individual mall pages or sites within the system can be adapted to provide hyperlinks to other sites or opportunities related to the respective malls.

What is claimed is:

1. A method for the rental of advertising space in facilities, comprising:
providing an information system which comprises a database, the database containing stored data upon a plurality of facilities which have space available for advertising and promotional purposes; allowing access to the database by users so that they may review the stored data and select at least one facility where they wish to use the available advertising space; and
providing a booking capability on the system such that the advertising space at the at least one facility may be booked by the user.

2. The method of claim 1, further comprising the step of providing an introduction capability on the system such that the user and the owner of the at least one selected facility may be put in contact with one another.

3. The method of claim 1, wherein users may only access the information database once they have registered and been assigned an identifying code by the system.

4. The method of claim 3, wherein the identifying code comprises a username and password.

5. The method of claim 1, further comprising the step of providing a search capability on the system so that a user may search for facilities whose data matches the requirements of that user.

6. The method of claim 2, wherein the facility owner may access the system via a secure intranet.

7. The method of claim 1, wherein the data stored in the database is selected from one or more of the group comprising geographical location, exclusions, pricing structure, footfall statistics, customer demographics, technical data, site dimensions, key retail occupants and site availability.

8. The method of claim 1, wherein the user accesses the system via the Internet.

9. The method of claim 1, wherein the plurality of facilities are shopping malls.

10. A system for the rental of advertising space in facilities, comprising:
a memory device storing a program;
a processor in communication with said memory; said processor operative with said program to:
provide a database containing stored data upon a plurality of facilities which have space available for advertising and promotional purposes;
allow access to the database by users so that they may review the stored data and select at least one facility where they wish to use the available advertising space; and provide a booking capability on the system such that the advertising space at the at least one facility may be booked by a user.

11. The system of claim 10, wherein the processor further provides an introduction capability such that a user may contact the owner of a selected facility directly.

12. The system of claim 10, wherein the database may only be accessed by a registered user having an identifying code.

13. The system of claim 12, wherein the identifying code is provided to the user by the system when the user accesses the system for the first time.

14. The system of claim 12, wherein the identifying code is a username and password.

15. The system of claim 10, wherein the data stored in the database is selected from one or more of the group comprising geographical location, exclusions, pricing structure, footfall statistics, customer demographics, technical data, site dimensions, key retail occupants and site availability.

16. The system of claim 10, wherein the system is accessed via the Internet.

17. The system of claim 10, wherein the system further comprises a telephone help center.

18. The system of claim 10, wherein the booking capability further comprises a secure intranet whereby a facility owner may view existing bookings.

19. The system of claim 10, wherein the plurality of facilities are shopping malls.
